(19) United States
(12) Patent Application Publication
(10) Pub. No.: US 2019/0391116 A1
(43) Pub. Date: Dec. 26, 2019

(54) TAPPING DEVICE

(71) Applicant: Tsung-Chih Yang, Hsinchu County (TW)

(72) Inventor: Tsung-Chih Yang, Hsinchu County (TW)

(21) Appl. No.: 16/431,717

(22) Filed: Jun. 4, 2019

(30) Foreign Application Priority Data
Jun. 22, 2018 (TW) 107121387

(51) Int. Cl. G01N 29/04; H01F 7/16; H01F 7/08; H01F 7/06; G01N 29/22; E04F 21/00; H04N 5/225

(52) U.S. Cl. CPC G01N 29/045; H01F 7/16; H01F 7/081; H04N 5/2257; G01N 29/226; E04F 21/00; H01F 7/064

(57) ABSTRACT

A tapping device suitable for use on tiles, bricks, floors, and walls is disclosed. The tapping device includes a pulse generator, a controller, and a plurality of push-pull solenoids, wherein the pulse generator is electrically connected to the controller. The controller includes a plurality of output pins and each output pin is respectively connected to each of the plurality of push-pull solenoids. The controller receives a square wave signal from the pulse generator and sequentially outputs a high potential signal at each output pin, and thus each push-pull solenoid sequentially extends and retracts to tap an adjacent floor or wall on the surface.

### REFERENCE TO RELATED APPLICATIONS

This non-provisional application claims priority claim under 35 U.S.C. § 119(a) on Taiwan Patent Application No. 107121387 filed Jun. 22, 2018, the entire contents of which are incorporated herein by reference.

### FIELD OF THE INVENTION

The invention relates to a tapping device, more particularly, to a tapping device that is capable of automatically tapping a floor or a wall to quickly and accurately complete a check on the tiles or bricks laid on the floor or the wall.

### BACKGROUND

Generally, after the installation of tiles or bricks on floors or walls, or after coating a floor or a wall with cement, laborious method is used to tap or knock on the completed tiles/bricks/floor/wall with hammer and detect whether there is a defect in the installation thereof through the tapping sound.

As for home buyers, tapping on floors or walls is also often used as a way to check the condition of the house. However, the aforementioned detection method is inefficient and has a potential of leaving some areas unchecked, especially when the floor or the wall has a large surface area, the laborious detection method would add to the loading of the inspector and reduce the efficiency and accuracy of the inspection.

### SUMMARY

An object of the invention is to provide a tapping device for inspecting tiles or bricks laid on a floor or a wall, or for inspecting a finished floor or a finished wall. The tapping device includes a pulse generator, a controller, and a plurality of push-pull solenoids. The controller is connected to the pulse generator for receiving a square wave signal from the pulse generator and includes a plurality of output pins, each of which is electrically connected to each of the plurality of solenoids respectively. The controller outputs a high potential signal sequentially at each of the plurality of output pins to drive each of the plurality of push-pull solenoids to extend sequentially, thereby enabling each of the plurality of solenoids to sequentially tap a tile, or a brick, or a floor, or a wall nearby and make a sound with each tapping. Through the tapping sound, user can determine whether there is a defect in the installation of tiles, bricks, floor, or wall. The tapping device would reduce the labor needed for tapping and inspection and also enhance the efficiency and accuracy of the inspection.

Another object of the invention is to provide a tapping device that includes a pulse generator, a controller, a plurality of push-pull solenoids, an image capturing unit for capturing surrounding images and sounds from the push-pull solenoid tapping on the floor or wall, and a storage unit for storing the captured images and sounds. Through an electronic device, the user can obtain the captured images and tapping sounds stored in the storage unit and acknowledge which region of the tiles/bricks/floor/wall is installed improperly. Hence, the tapping device is enhanced in usability and convenience.

To achieve the aforementioned objects, the invention provides a tapping device including a pulse generator, a controller, and a plurality of push-pull solenoids. The pulse controller generates a square wave signal. The controller includes an input pin electrically connected to the pulse generator for receiving the square wave signal and a plurality of output pins electrically connected to the plurality of push-pull solenoids respectively. After receiving the square wave signal, the controller outputs sequentially a high potential signal at each of the plurality of output pins to enable each of the plurality of push-pull solenoids to extend and retract sequentially.

In one embodiment of the invention, the tapping device further includes a housing, wherein the pulse generator and the controller are disposed in the housing and the push-pull solenoids are disposed on the housing.

In one embodiment of the invention, the tapping device further includes a wheel body disposed on a bottom of the housing for carrying the housing to move around on a surface.

In one embodiment of the invention, the tapping device further includes a rod connected to the housing.

In one embodiment of the invention, the tapping device further includes an image capturing unit disposed on the housing for capturing images and sounds from the push-pull solenoids tapping the surface.

In one embodiment of the invention, the tapping device further includes a storage unit electrically connected to the image capturing unit for storing the images and sounds captured by the image capturing unit.

In one embodiment of the invention, the tapping device further includes a power unit electrically connected to the controller, the pulse generator, and the image capturing unit.

In one embodiment of the invention, the tapping device further includes a connector socket disposed in the housing for electrically connecting the power unit and the storage unit.

In one embodiment of the invention, the tapping device further includes a heat-conductive casing disposed at an outer portion of the push-pull solenoids.

In one embodiment of the invention, wherein each of the push-pull solenoids includes an extendible portion and a cushion unit disposed on an end of the extendible portion that taps the surface.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIG. 1 is a block diagram of a tapping device according to an embodiment of the invention.

FIG. 2 is a schematic diagram of a tapping device according to an embodiment of the invention.

FIG. 3 is a schematic diagram illustrating a plurality of push-pull solenoids of a tapping device according to an embodiment of the invention.

FIG. 4 is a schematic diagram illustrating a circuit connection of a tapping device according to an embodiment of the invention.

### DETAILED DESCRIPTION OF THE PREFERRED EMBODIMENTS

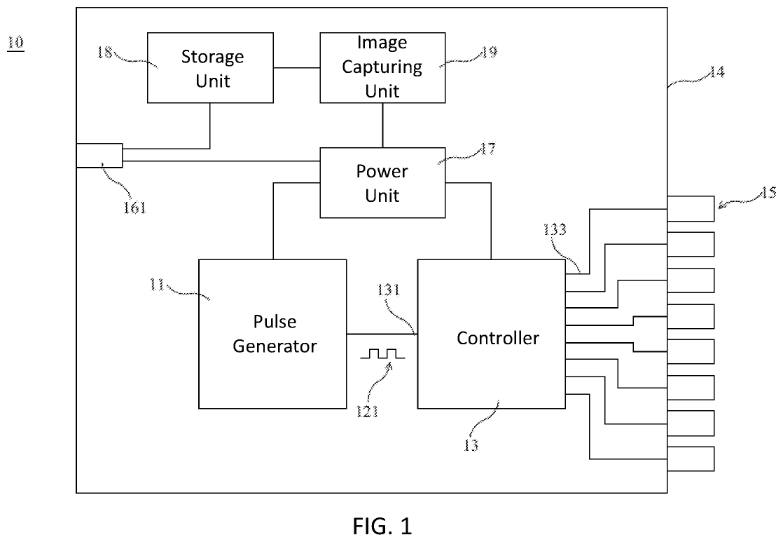

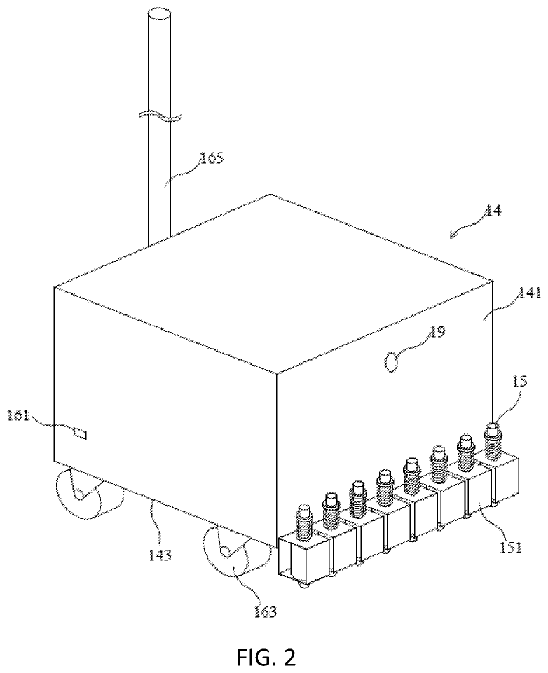

FIGS. 1 and 2 are, respectively, a block diagram and a schematic diagram of a tapping device according to a preferred embodiment of the invention. The tapping device 10 includes a pulse generator 11, a controller 13, and a plurality of push-pull solenoids 15, wherein the pulse generator 11 is electrically connected to the controller 13, and the controller 13 is electrically connected to the plurality of push-pull solenoids 15

The pulse generator 11 generates a square wave signal 121 and transmits the square wave signal 121 to the controller 13. The controller 13 includes an input pin 131 and a plurality of output pins 133, wherein the input pin 131 is electrically connected to the pulse generator 11 and receives the square wave signal 121 and each of the plurality of output pins 133 sequentially outputs a high potential signal. The pulse generator 11 can be, for example, a 555 timer IC and the controller 13 can be a CD4017 circuit. The circuit connection will be described in detail in a later embodiment and the 555 timer IC and the CD4017 circuit are merely embodiments of the invention and do not limit the scope of the invention thereby. Other circuits or integrated chips may also be applied.

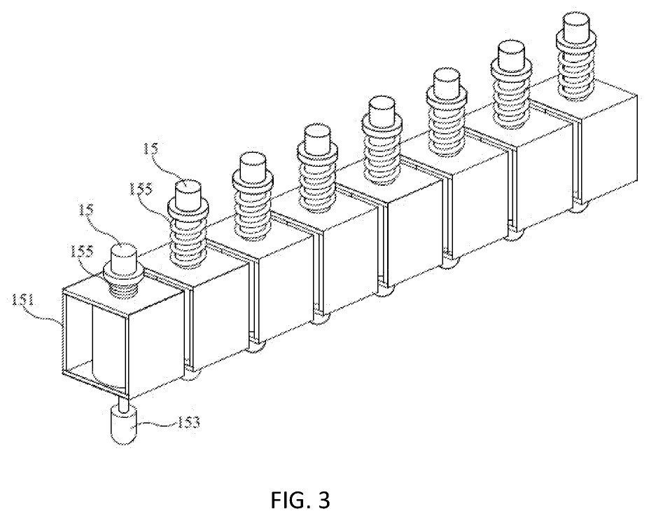

Each of the output pins 133 of the controller 13 is connected respectively to each of the push-pull solenoids 15, wherein the push-pull solenoid 15 extends when receiving the high potential signal and retracts when the high potential signal is gone. As shown in FIG. 3, as the first push-pull solenoid 15 in the figure receives the high potential signal, an extendible portion 153 of the push-pull solenoid 15 extends and taps or knocks a surface of a floor or a wall underneath or adjacent thereto. When the high potential signal is gone, the extendible portion 153 of the push-pull solenoid 15 retracts to its original position due to the force of a spring 155. Moreover, a cushion unit is disposed on one end of the extendible portion that taps the floor, and the cushion unit is, for example, a rubber or plastic material to prevent the tiles from breaking by the tapping of the extendible portion 153 during the inspection.

Each output pin 133 of the controller sequentially outputs the high potential signal and thus each of the push-pull solenoids 15 that respectively connects to each of the plurality of output pin 133 extends and retracts sequentially to tap the tiles/bricks or the floor/wall underneath or adjacent thereto sequentially. The user can determine whether the tiles/bricks or the floor/wall being tapped is installed properly based on the sound made by the push-pull solenoid 15 tapping on the tiles/bricks or the floor/wall.

In one embodiment shown in FIG. 2, the pulse generator 11 and the controller 13 are disposed in a housing 14 which provides protection to the two chips. More specifically, the pulse generator 11 and the controller 13 can be disposed on a circuit board and then placed in the housing 14. The push-pull solenoids 15 are disposed on the housing 14. For example, each push-pull solenoid 15 is disposed below a front side 141 of the housing 14 and arranged in an up-right position, such that when the push-pull solenoid 15 extends, it will tap the tiles/bricks or the floor/wall underneath.

The housing 14 can also include at least one wheel body 163 disposed thereon. The wheel body 163 may be disposed on a bottom 143 of the housing 14 and carries and moves the housing 14 around on a surface such as a ground or a floor or a wall. In addition, the housing 14 can also be connected to a rod 165, like on a back side of the housing 14. The user can hold the rod 165 and move the tapping device 10 on the floor or the wall so the push-pull solenoids 15 tap the floor/wall surface underneath while passing by and thereby completing the inspection of the tiles/bricks/floor/wall.

In one embodiment of the invention, the tapping device 10 includes a power unit 17, wherein the power unit 17 is electrically connected to the pulse generator 11 and the controller 13, respectively, to provide power. The power unit 17 can be a battery or a rechargeable battery.

In another embodiment of the invention, the tapping device 10 includes an image capturing unit 19 disposed on the housing 14 and electrically connected to the power unit 17. The image capturing unit 19 captures surrounding images of the tapping device 10 and sounds generated from the push-pull solenoids 15 tapping on the tiles/bricks or the floor/wall. The image capturing unit 19 can be a digital camera with video and audio recording functions.

The image capturing unit 19 is electrically connected to a storage unit 18 and stores the captured images and sounds in the storage unit 18. Through the use of the image capturing unit 19 and the storage unit 18, the position of the tapping device 10 can be recorded along with corresponding tapping sound from the tiles/bricks or floor/wall at that position.

In practical application, the user can know the installation quality of the tiles/bricks or the floor/wall from the images and sounds stored in the storage unit 18 and further determine which regions have defects. In one embodiment of the invention, a connector socket 161 is disposed on the housing 14 of the tapping device 10 and electrically connected to the storage unit 18 and the power unit 17; the connector socket 161 is a USB connector socket.

User can connect an electronic device like a computer to the connector socket 161 via a connecting line such as an USB cable and transmit the images and sounds stored in the storage unit 18 to the electronic device so as to view the inspection result on the electronic device. In specific, residents are able to inspect the floor/wall with the tapping device 10 by themselves and send the images and sounds of the inspection result to the repairman, and then the repairman can determine the position of the defected tiles/bricks or floor/wall via the images and sounds and repair accordingly. Hence, the time spent on multiple inspections is saved. Furthermore, the user can also connect a power terminal, like a power socket, to the connector socket 161 via the connecting line such as an USB cable and provide power to the power unit 17 through the connector socket 161.

Referring to FIG. 3, a heat-conductive casing 151 is disposed on an outer portion of the push-pull solenoid 15 according to another embodiment of the invention. The push-pull solenoids 15 are disposed on the housing 14 through the heat-conductive housing 151. The heat-conductive casing 151 is made of a metal material.

Each push-pull solenoids 15 includes a coil and a slidable iron core disposed therein and drives the slidable iron core to move by providing electricity to the coil. Therefore, after a period of time during usage, heat energy may be generated in the push-pull solenoids 15. By disposing the heat-conductive casing 151 on the outer portion of the push-pull solenoid 15, the heat-conductive casing 151 is in contact with a portion of the pus-pull solenoid 15 and conducts the heat generated in the push-pull solenoid 15 out via heat conduction. For example, the heat-conductive casing 151 can be disposed on the top, the bottom, the front side and the back side of the push-pull solenoid 15. In addition, the heat-conductive casing 151 is not disposed on the left side and the right side of the push-pull solenoid 15, such that the push-pull solenoid 15 is in fluid communication with the outer environment and the heat generated in the push-pull solenoid 15 is conducted out via heat convection.

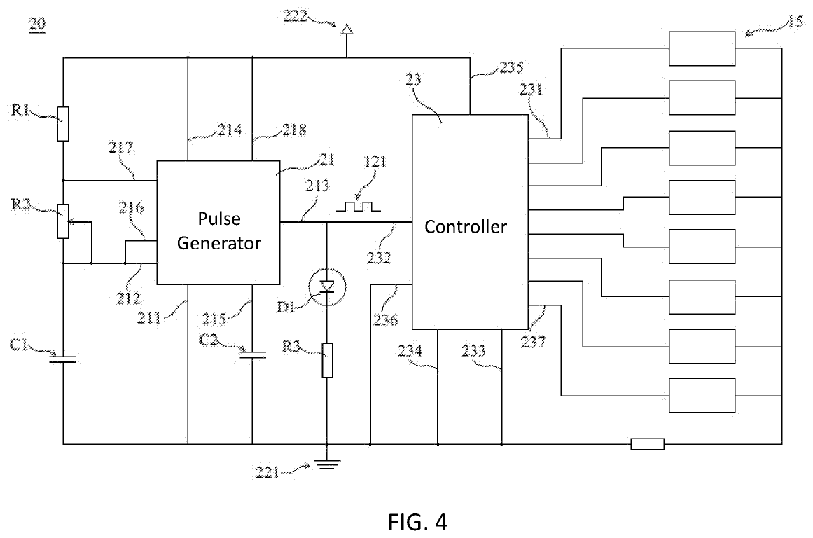

FIG. 4 is a schematic diagram illustrating a circuit connection of a tapping device according to an embodiment of the invention. The tapping device 20 includes a pulse generator 21, a controller 23, and a plurality of push-pull solenoids 15, wherein the pulse generator 21 is electrically connected to the controller 23, and the controller is electrically connected to each of the plurality of push-pull solenoids 15.

The pulse generator 21 can be a 555 timer IC, which includes 8 connecting pins, like a ground pin 211, a trigger pin 212, an output pin 213, a reset pin 214, a control pin 215, a threshold pin 216, a discharge pin 217, and a positive supply pin 218.

A power supply voltage 222 is connected to a ground 221 via a first resistor R1, a second resistor R2 and a first capacitor C1 connected in series, wherein the trigger pin 212 and the threshold pin 216 are jointly connected and are connected between the second resistor R2 and the first capacitor C1, and the discharge pin 217 is connected between the first resistor R1 and the second resistor R2. Specifically, the 555 timer IC is operated in an astable mode and the frequency of the square wave signal 121 output by the output pin 213 is determined by the first resistor R1, the second resistor R2, and the first capacitor C1.

The ground pin 211 is connected to the ground 221, and the control pin 215 is connected to the ground 221 via a second capacitor C2. The positive supply pin 218 and the reset pin 217 are connected to the power supply voltage 212 to provide power to the pulse generator 21.

The controller 13 can be a CD4017 circuit, which includes a plurality of pulse output pins 231, a clock input pin 232, a disable pin 233, a ground pin 234, a power supply pin 235, a reset pin 236, and a carry pulse input pin 237. The power supply pin 235 is connected to the power supply voltage 222 and the ground pin 234, the disable pin 233, and the reset pin 236 are connected to the ground 221.

The clock input pin 232 of the CD4017 circuit is connected to the output pin 213 of the 555 timer IC for receiving the square wave signal 121. Moreover, a diode D1 and a third resistor R3 can also be used between the output pin 213 and the clock input pin 232 to connect to the ground 221.

Each pulse output pin 231 of the CD4017 circuit can connect to a push-pull solenoid 15 respectively. When the pulse output pin 231 outputs a high potential signal, the push-pull solenoid 15 connected to that pulse output pin 231 extends and taps the floor underneath or adjacent thereto.

It is to be noted that the 555 timer IC and the CD4017 circuit described in FIG. 4 are merely an embodiment of the invention and the structure, layout, connection and design of the invention are not limited thereby.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. A tapping device comprising:
a pulse generator for generating a square wave signal;
a controller comprising an input pin and a plurality of output pins, wherein the input pin is electrically connected to the pulse generator for receiving the square wave signal from the pulse generator; and
a plurality of push-pull solenoids respectively connected to the plurality of output pins, wherein after receiving the square wave signal, the controller outputs a high potential signal at each output pin sequentially to enable each push-pull solenoid to extend and retract sequentially.

2. The tapping device of claim 1, further comprising a housing, wherein the pulse generator and the controller are disposed in the housing and the push-pull solenoids are disposed on the housing.

3. The tapping device of claim 2, further comprising a wheel body disposed on a bottom of the housing for carrying the housing to move around on a surface.

4. The tapping device of claim 3, further comprising a rod connected to the housing.

5. The tapping device of claim 3, further comprising an image capturing unit disposed on the housing for capturing images and sounds, wherein the sounds are tapping sounds from the push-pull solenoids tapping on the surface.

6. The tapping device of claim 5, further comprising a storage unit electrically connected to the image capturing unit for storing the images and the sounds captured by the image capturing unit.

7. The tapping device of claim 6, further comprising a power unit electrically connected to the controller, the pulse generator, and the image capturing unit.

8. The tapping device of claim 7, further comprising a connector socket disposed on the housing for electrically connecting the power unit and the storage unit.

9. The tapping device of claim 1, further comprising a heat-conductive casing disposed on an outer portion of the push-pull solenoids.

10. The tapping device of claim 1, wherein each of the push-pull solenoids comprises an extendible portion and a cushion unit, and the cushion unit is disposed on an end of the extendible portion being used to tap a surface.
